(19) United States
(12) Patent Application Publication
(10) Pub. No.: US 2012/0216927 A1
(43) Pub. Date: Aug. 30, 2012

(54) Handbag System and Method

(76) Inventor: Linda Marier, San Diego, CA (US)

(21) Appl. No.: 13/402,731

(22) Filed: Feb. 22, 2012

Related U.S. Application Data
(60) Provisional application No. 61/446,462, filed on Feb. 24, 2011.

(51) Int. Cl. A45C 3/08; B29C 33/38; B29C 67/00; B23P 17/00

(52) U.S. Cl. 150/105; 29/527.1; 264/219

(57) ABSTRACT

A handbag having a seamless inner compartment comprised of a core made from plastic foam materials, a magnet embedded within the core material about a rim of the inner compartment and a decorative material covering the core material. The handbag also having an outer compartment, within which the inner compartment fits, also having a core and cover, as well as a magnet or magnetic metal material about its rim. The inner compartment fits within the outer compartment and is secured within the outer compartment via the positions and mutual attraction of the magnets and magnetic materials in the respective rims.

The present application claims the benefit and priority of and incorporates by this reference U.S. Provisional Application No. 61/446,462 filed with the United States Patent and Trademark Office on Feb. 24, 2011.

### BACKGROUND OF THE INVENTION

1. Field of the Invention

The present invention pertains generally to handbags and methods for making handbags. More specifically, the present invention, in a preferred embodiment, is useful as a handbag having and method for making separable inner and outer compartments to provide improved utility.

2. Background of the Invention

It is typical for a person to own several different handbags for a wide variety of functions and occasions. In addition to different functional aspects of varying handbags, there are also a variety of color schemes and designs needed to fashionably go with a particular outfit or occasion.

Different occasions or different attire may call for a particular kind or appearance of handbag. However, moving the contents of one handbag into a different handbag can be problematic. Changing handbags to suit every situation is troublesome, yet no single handbag can suffice for a wide variety of occasions.

Accordingly, there remains a need to improve the way inner and outer compartments connect and detach and further improvement in manufacturing can fill another need. In light of the situation herein, it is an object of the present invention to provide a Handbag System and Method that is more useful and beneficial than prior solutions. More specifically, it is an object of the present invention to provide a handbag system and method of manufacture that improves utility and manufacturing; to make the inner and outer handbag construction attractive and appealing to the user as it can be with intimate apparel; to design and make the exterior and interior construction for easier maintenance, washing and storage; and to provide an improved cost effective approach in manufacturing handbags.

### SUMMARY OF THE INVENTION

The present invention specifically addresses and alleviates the above mentioned deficiencies associated with the prior art.

More particularly, the present invention may be characterized in a first aspect as a versatile handbag comprising an inner compartment, the inner compartment including: a core material made from polyurethane foam or other plastic foam materials; an elongated rectangular magnet embedded within the core material having a longitudinal axis substantially about a rim of the inner compartment; and a spandex or other similar material covering the core material (on the outside and/or the inside), wherein a shape of the inner compartment is seamless.

The handbag of the present invention may be additionally characterized as comprising an outer compartment, the outer compartment including: a cover (including but not limited to cloth, leather, plastic and synthetic fiber) material formed substantially to cover the inner lining, the cover forming a seam on lateral sides; and an elongated bendable rectangular metal material having a longitudinal axis substantially about a rim of the outer compartment. The invention may further include a grommet adjacent to the elongated metal material and substantially aligned to the longitudinal axis of the metal material, wherein the metal material is configured to be juxtaposed to the rectangular magnet.

In a second aspect, the present invention may be characterized as a method of making a handbag inner compartment comprising: creating a mold in a shape of a pouch, the pouch including a proximal opening, a distal edge, and first and second lateral sides, the proximal opening further including a rim around a circumference thereof; filling the mold with polyurethane or similar material; filling the mold with spandex or similar cover material; and aligning a ferromagnetic material along the rim thereby creating a handbag inner compartment with a seamless appearance.

These, as well as other advantages of the present invention will be more apparent from the following description and drawings. It is understood that changes in the specific structure shown and described may be made within the scope of the claims (e.g., different sizes and shapes), without departing from the spirit of the invention.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112.

The above-description sets forth, rather broadly, a summary of example embodiments of the present invention so that the detailed description that follows may be better understood and the contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

The invention can be better visualized by turning now to the following drawings wherein like elements are expressed using like-referenced characters.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a first embodiment of the present invention showing inner and outer compartments;

FIG. 2 is a side aspect of the inner compartment of the first embodiment;

FIG. 3 is an end view of the inner compartment;

FIG. 4 illustrates a sectional view taken along lines 4-4 of FIG. 2;

FIG. 5 is a side view of an outer compartment showing the inner compartment as hidden lines;

FIG. 6 is an end view of the configuration shown in FIG. 5;

FIG. 7 illustrates a sectional view taken along lines 7-7 in FIG. 5;

FIG. 8 illustrates a second handbag embodiment having a decorative outer compartment;

FIG. 9 is a side aspect view of the second embodiment inner compartment;

FIG. 10 illustrates an end view of the second embodiment;

FIG. 11 illustrates a sectional view of the inner compartment taken along lines 11-11 in FIG. 9;

FIG. 12 is a side view of the second embodiment outer compartment showing the inner compartment as hidden lines;

FIG. 13 is an end view of the configuration shown in FIG. 14; and

FIG. 14 illustrates a sectional view taken along lines 14-14 in FIG. 12.

### DESCRIPTION OF PREFERRED EMBODIMENTS

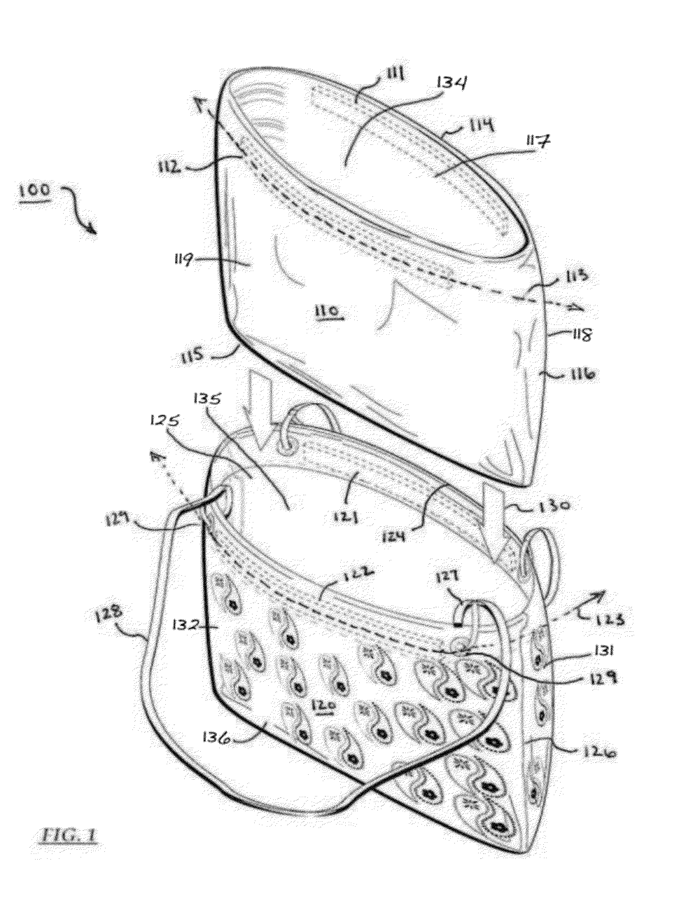

Initially referring to FIG. 1, an exemplarily versatile handbag 100 is shown wherein arrows 130 illustrate an inner compartment 110 able to snugly fit inside outer compartment 120. The inner compartment may hold items to be transferred to different outer compartments 120 as a user desires. Inner compartment 110 may be characterized as having an upper rim 114 forming a pouch opening 117 and converging to a bottom edge 115. The inner compartment 110 may be further characterized as having proximal pouch opening 117 at the top, a distal, bottom edge 115 at the bottom, and first and second lateral sides 118 and 119. As shown, the distal edge 115 and first and second lateral sides 118, 119 define an inner pocket 134. Sides 118 and 119 merge to define ends 116 at opposite ends of the inner compartment 110. Sides 118 and 119 may merge or connect in various ways, such as by molding as described in further detail below.

As also shown, an area underneath rim 114 is defined by longitudinal axis 113 about the upper rim 114 area. First and second elongated magnet materials 111 and 112 (e.g., including without limitation, magnets, ferromagnetic materials, and metallic materials with magnetic or magnet attracting properties) are configured about the rim 114 as shown. The magnets 111, 112 are further shown as dashed lines because they are preferably physically embedded within the material comprising the core material 420 of inner compartment 110 as additionally described herein. Also as shown, elongated magnet 112 is formed symmetrical about axis 113 that extends along side 119 of the inner compartment 110. Further the elongated magnet 112 substantially occupies the length of the rim 114 on side 119. Magnet 111 is located similarly along rim 114 of side 118. In a specific preferred embodiment, the upper rim 114 area may be additionally characterized as extending downward approximate one inch from the rim 114; and therefore longitudinal axis 113 would be approximately one-half inch from the rim 114.

Magnets 111 and 112 can take various forms, including generally flat, elongated strips as shown in FIG. 1. Magnets 111 and 112 may also take the form of tubes, rods, disks, plates, beads, strips and other suitable shapes. Magnets 111 and 112 may extend varying lengths along sides 118 and 119. Magnets 111 and 112 may extend around the entirety of or part of the entirety of rim 114. Magnets 111 and 112 also provide a means to fix the opening 117 in a closed position by securing to each other.

Continuing with regard to FIG. 1, an outer compartment 120 similarly has an upper rim 124 area with elongated magnetic materials 121 and 122 (e.g., including without limitation, magnets, ferromagnetic materials, metallic materials with magnetic or magnet attracting properties) on opposite sides of the outer compartment. Similar variations of the size, shape and orientations of magnets 121 and 121 to those described above for magnets 111 and 112 can be used as well (e.g., strips, tubes, rods, disks, plates, beads, strips and other suitable shapes; located along an area below the rim 124 and extending substantially along a longitudinal circumference or axis 123 about rim 124). Outer compartment 120 similarly has a proximal opening 125 at the top, a distal edge 136 at the bottom, and first and second lateral sides 131 and 132, whereby the distal edge 136 and first and second lateral sides 131 and 132 define an inner pocket 135. Akin to sides 118 and 119 and ends 116 of inner compartment 110, sides 131 and 132 similarly merge to form ends 126 at opposite ends of the outer compartment 120. The inner compartment 110 fits within the inner pocket 135 of the outer compartment 120. Also similarly, longitudinal axis 123 will circumscribe upper rim 124 area. As shown, side magnet 122 is symmetrical about longitudinal axis 123 on side 132, as is magnet 121 on side 131.

As indicated parenthetically above, magnets 111, 112, 121 and 122 are comprised of magnets and/or metallic materials with magnetic or magnet attracting properties. As such, they magnetically attract to each other. Accordingly, magnets 111, 112, 121 and 122 may all comprise magnets and attract to each other. And, magnets attract to metal, so magnets 111, 112, 121 or 122 may comprise metal so long as the metal is magnetic, magnetically attractive or otherwise has magnet attracting properties. Accordingly, for example, magnets 111 and 112 may comprise magnets and attract to magnets 121 and 122 comprising metal strips. Alternatively, magnets 121 and 122 may comprise magnets and attract to magnets 111 and 112 comprising metal strips. Again alternatively, magnets 111 and 122 may comprise magnets and attract to magnets 121 and 112 comprising metal strips.

Additionally, while optional, as shown in FIG. 1 for outer compartment 120, grommets 129 are aligned symmetrical about the axis 123 and adjacent to ends of magnets 121 and 122. In a preferred embodiment, grommets 129, each form a small loop 127 for a handbag strap 128, the small loops 127 in turn connect the larger side strap 128 in side 132 of the outer compartment. The opposite side 131 of the handbag 100 will have an identical configuration. When used, grommets 129 preferably comprise pairs of corresponding grommets on each side of the rim of the outer compartment as shown in FIG. 1. Grommets 129 and strap 128 are similarly capable of being similarly formed in the inner compartment 110.

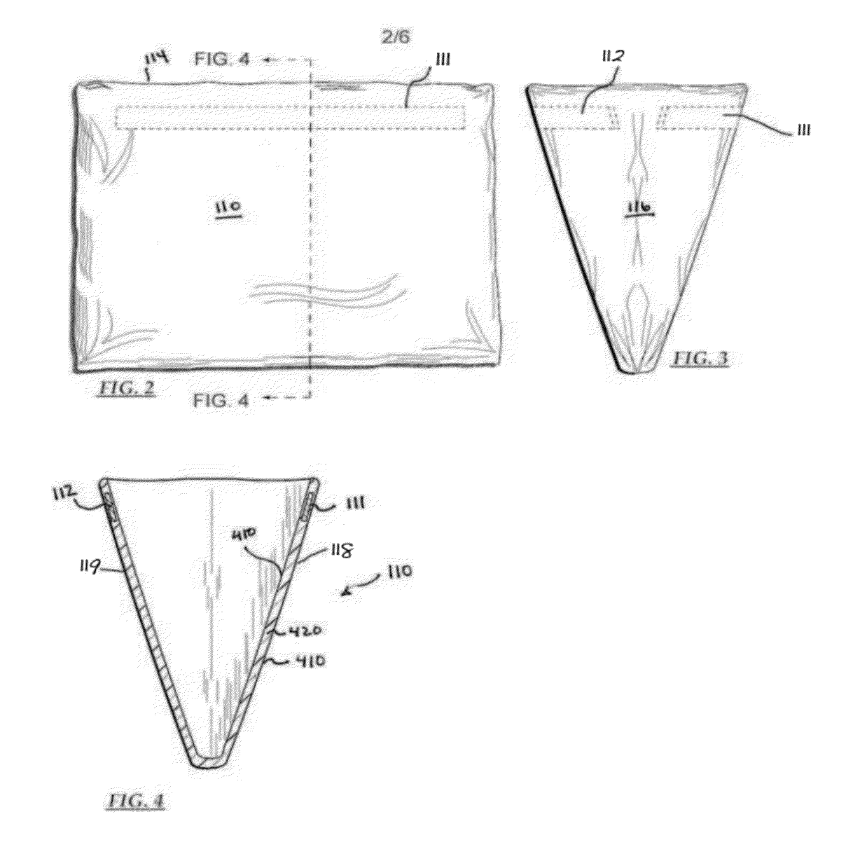

FIG. 2 illustrates a profile view of an inner compartment 110 of a preferred embodiment of the present invention. FIG. 3 further shows an end view of the inner compartment 110 wherein end 116 is preferably seamless. FIG. 4 illustrates a cross-sectional view of inner compartment 110 taken along sectional line 4-4 in FIG. 2. It can be seen from this view that inner compartment 110 comprises a core material 420 preferably made from polyurethane or similar plastic foam material. However, core material 420 can also be made from other materials, such as cotton, wool, felt, other cloth (fabric), leather or sponge. A skin material 410 is provided for the core material 420 that preferably comprises flexible synthetic fiber, such as spandex, Lycra, nylon or similar material, but could include cloth (fabric), leather or plastic. Skin material 410 may be provided for the cover material 420 as an additional layer of material on the core material 420. Skin material 410 may also be provided for the core material 420 as material merged to the core material 420, such as by heat pressing, heat molding, stitchless bonding, welding or other molding techniques, as further described below. The first and second lateral sides 118 and 119 comprise the core material 420 and skin material 410, with skin material 410 on the outside surface of the lateral sides 118, 119 as shown in FIGS. 2 to 4.

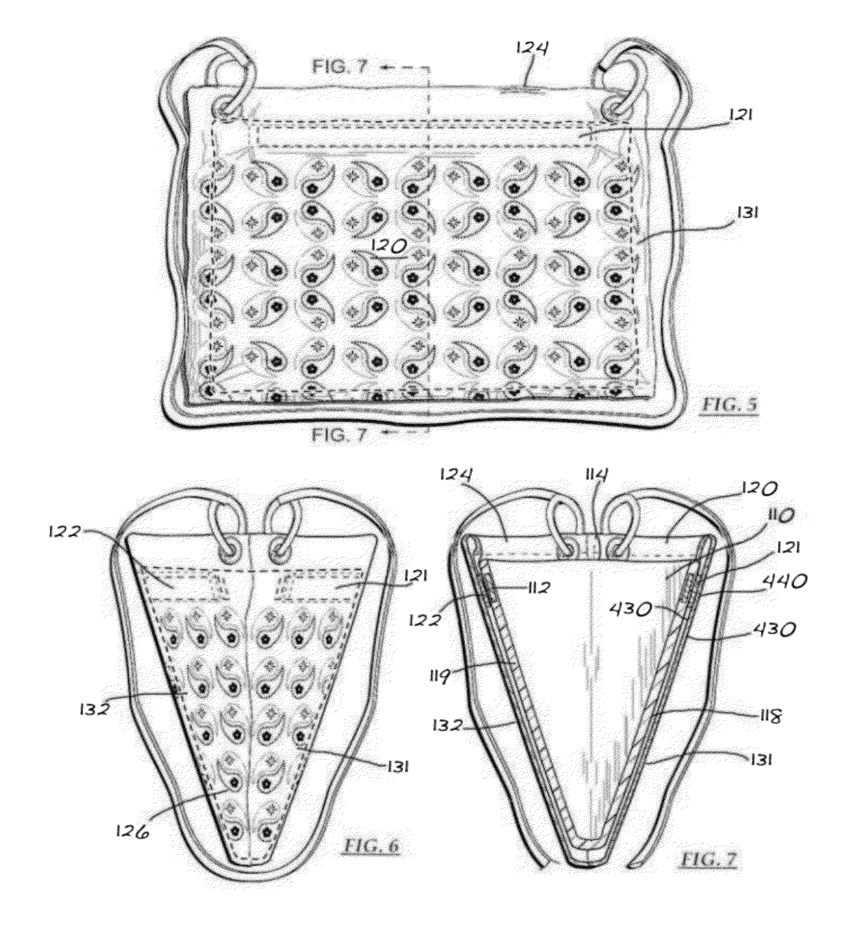

FIG. 5 also illustrates a profile view of an outer compartment 120 of a preferred embodiment of the present invention. FIG. 6 further shows an end view of the outer compartment 120. The distal edge 136 and end 116 can have a seam or be seamless. FIGS. 5 and 6 also show the exterior outline of inner compartment 110 with dashed lines. FIG. 7 illustrates a cross-sectional view of outer compartment 120 taken along sectional line 5-5 in FIG. 5. It can be seen from this view that outer compartment 120 comprises a core material 440, which can be made from polyurethane or similar plastic foam material, as well as cotton, wool, felt, other cloth (fabric), leather or sponge. A skin material 430 is provided for the core material that preferably comprises flexible synthetic fiber, such as spandex, Lycra, nylon or similar material, but could include cloth (fabric), leather or plastic. Materials 430 and 440 may comprise flexible and stretchable fabric to snugly fit over the inner compartment 110 in whole or in part. The first and second lateral sides 131, 132 comprise the core material 440 and skin material 430, with skin material 430 on the outside surface of the lateral sides 131 and 132. Alternatively, skin material 430 and core material 440 are hemmed to form a slot 141 within rim area 114 for magnets 121 and 122. Materials 430 and 440 can be similarly folded or seamed. In this case, core material 440 comprises the inner surface of the lateral sides 131 and 132 adjacent the hemmed slot. Core material 440 can further comprise material within the slot 141, such as polyurethane or similar foam material, cotton or other fabric. Magnets 122 and 121 are contained, surrounded or otherwise embedded in the core material 440 of the rim 114 in either case. As such, rim 114 includes an exterior portion comprising skin material 410 and an interior portion comprising core material 420.

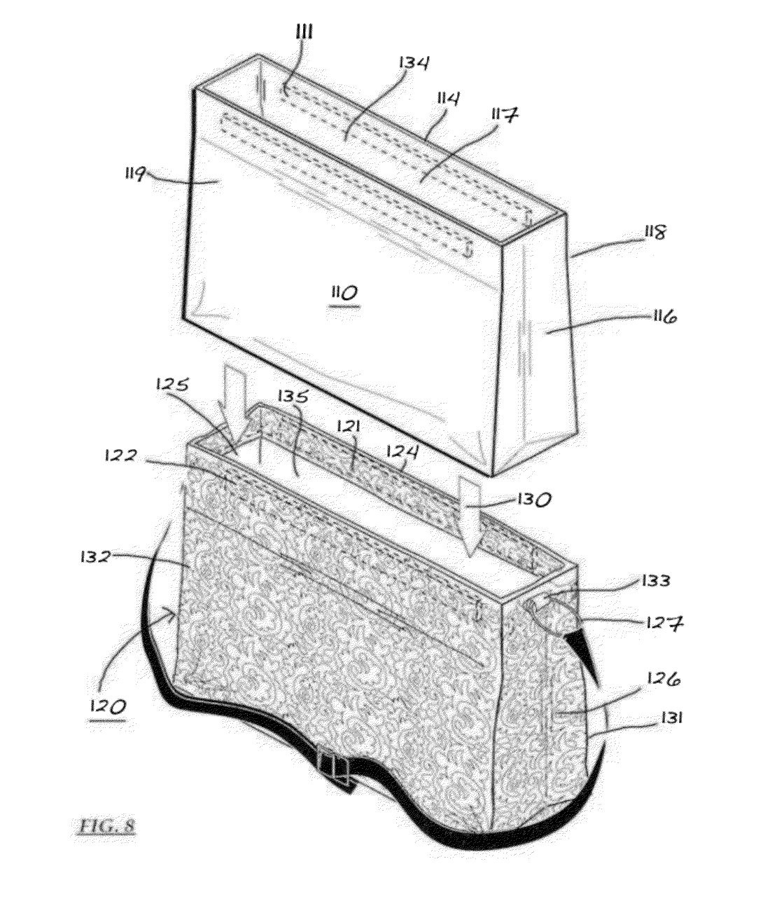

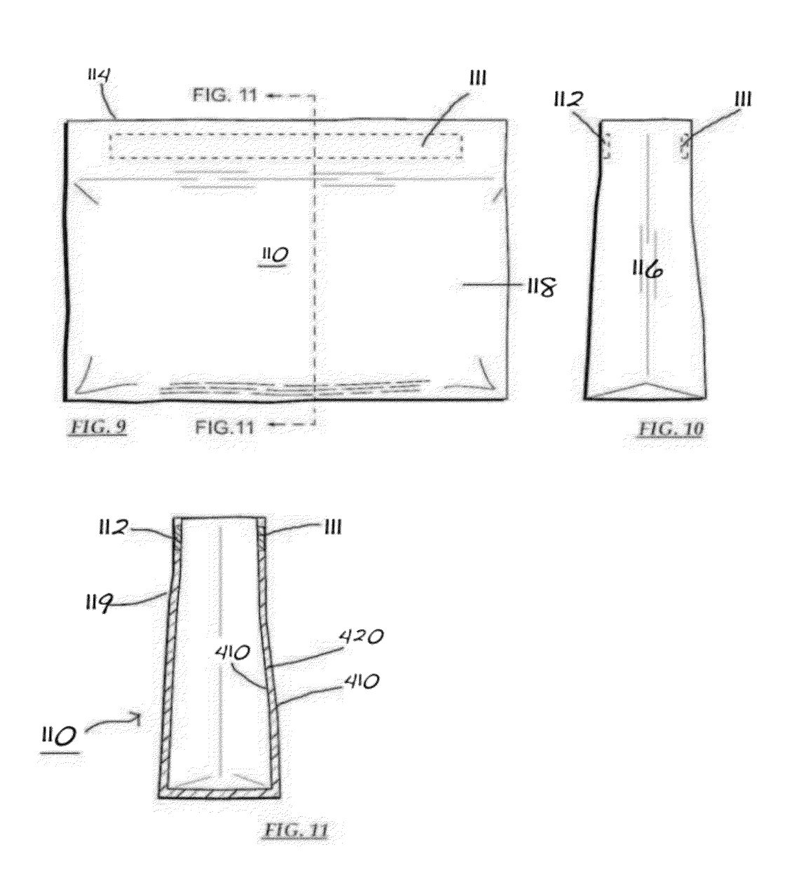

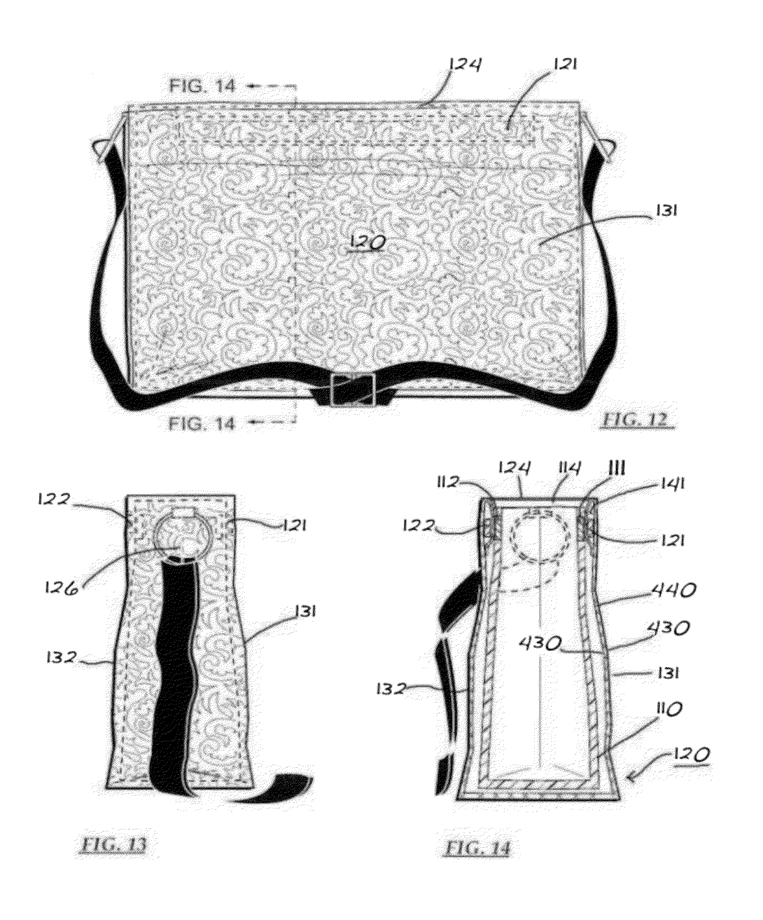

FIGS. 8 to 14 illustrate an additional embodiment of the handbag 100 of the present invention having squared shapes for the inner compartment 110 and outer compartment 120 as compared to the rounded shapes of the embodiment in FIGS. 1 to 7. As shown, the components of the handbag 100 identified in FIGS. 8 to 14 are the same as those identified above for FIGS. 1 to 7 and described above. Like FIG. 1, FIG. 8 illustrates the inner compartment 110 fitting within the inner pocket 135 of outer compartment 120 for this additional squared shaped embodiment. An additional alternative grommet arrangement (akin to 129) is shown in FIG. 8 comprising tube 133 and small loop 127. Like FIGS. 2 and 3, FIG. 9 is a side aspect view of the inner compartment 110, and FIG. 10 illustrates an end view including end 116. Like FIG. 4, FIG. 11 illustrates a sectional view of the inner compartment 110 taken along lines 11-11 in FIG. 9 for the alternative embodiment. The skin material 410 and core material 420 surrounding the magnets 111 and 112 are shown. Like FIGS. 5 and 6, FIG. 12 is a side view of the second embodiment outer compartment 120 showing the inner compartment 110 as hidden lines, and FIG. 13 is an end view of the embodiment of handbag 100 shown in FIG. 5 (including end 126) and the configuration of the embodiment shown in FIG. 14. Akin to FIG. 7, FIG. 14 illustrates a sectional view taken along lines 14-14 in FIG. 12. The skin material 430 around the core material 440 that surrounds the magnets 121 and 122 in slot 141 in rim area 124 is shown.

In an additional alternative embodiment, the magnets 111, 112, 121 and 122 may alternatively be placed in places other than the upper rim areas 114 and 124, such as along the bottom edges 115 and 136 or middle area of the sides 118, 119, 131 and 132. The magnets 111, 112, 121 and 122 in the inner and outer compartments 110 and 120 are aligned in these alternative embodiments in similar fashion as to the preferred embodiments. The difference is that the inner compartment 110 is secured to the outer compartment 120 at the bottom 115 and 136 or middle area of the sides 118, 119, 131 and 132 instead of at the rims 114 and 124.

The inner compartment 110 and outer compartment 120 of the present invention can be made by various methods. These may include conventional sewing methods, whereby each material component of the compartment is sewn together, at least in part. Preferably however, heat pressing, heat molding, stitchless bonding, welding or other molding techniques are used to provide a seamless appearance at the junctions of the first and second lateral sides 118, 119 (e.g., along the distal bottom edge 115 and ends 116) of the inner compartment 110. The outer compartment 120 may be similarly molded at the junctions of lateral sides 131 and 132 at distal edge 136 and ends 126. Any suitable molding technique may be used, e.g., again, at least heat pressing, heat press molding, stitchless bonding, welding or other molding techniques. Molding techniques include simple molding, such applying moldable synthetic materials around sewn materials to cover the seams. Molding techniques include advanced molding, such as using preformed molds as described below.

Accordingly, the inner compartment 110 is preferably made, at least in part, by molding the core and skin materials 420 and 410 with magnetic materials 111, 112 inserted during the molding process. The outer compartment 120 can be made by the same processes, utilizing corresponding core and skin materials 440 and 430. However, the outer compartment 120 is preferably made by sewing methods. The seam of the outer compartment 120 is sometimes a desirable design feature. Further, the skin core material 420 provides design surface for the outside of the outer compartment. More desirable design patterns are available in cloth, plastic and leather materials for handbags. Accordingly, sewing is often used in assembling the sides and core and skin materials 440 and 430 of the outer compartment 120.

However, in further description of molding techniques, with the advent of moldable synthetic materials such as foam and synthetic fabric materials, handbag forms (similar to bra cup forms) are moldable into a single panel of material or assembly of panels of materials to define a three dimensional handbag form.

In one embodiment, this is accomplished by providing a laminated structure of a first panel of a flexible foam material (core material 420) and a second panel material (skin material 410). When molded, the first and second panels are substantially coextensive to each other and define a handbag perimeter shape, including lateral sides 118 and 119 with preferably seamless bottom edge 115 and ends 116 using inner compartment 110 for example. The first panel of flexible foam material (core material 420) may be of constant or varying thickness. Variance in thickness provides a zone of greater thickness at a region or regions away from the perimeter as compared to regions of lesser thickness more proximate to the perimeter. Similarly, many different shapes may be used. Further, changes can be made to shapes during the molding process.

As such, panels are assembled, laminated and molded together in a molding device. The magnetic materials (111, 112 for the inner compartment 110, and 121, 121 for the outer compartment 120, are used interchangeably herein) are also inserted between multiple panels or in openings of the core material 420 to embed the magnet 111, 112 in the core 420 upon molding. For example, the molding device consists of two mold portions each having formed therein a profile or contour of a kind to introduce into the panel assemblies the three dimensional pouch shape of the handbag 100. The upper mold portion for example includes a convex impression and the lower portion includes a concave relief of a substantially complimentary shape to form the pouch shape, including the seamless appearance of the bottom 115 and ends 116 of sides 118 and 119 and the inner shape of inner pocket 134 as shown in FIGS. 1 to 4 and 8 to 11 for inner compartment 110.

The assemblies of panels of core and skin material (e.g., again, 420 and 410 for the inner compartment 110 and 440 and 430 for the outer compartment 120, used interchangeably herein) are positioned intermediate of the mold portions in a manner so that they overlay each other in an appropriate condition (preferably coextensively) whereupon the two mold portions are then brought together. The magnet materials 111, 112 are placed within the panels of core material 420. The two mold portions are preferably heated. Additional adhesive may be placed intermediate of the assemblies so that both pressure adhesive and heat will ensure that a good laminated bond can be established between the two subassemblies. Upon the formation of the pouch form into the panel assemblies, the intersections of the panels can further be molded so as to embed the magnets 111, 112 in the core material 420 and to exclude visible seams For example, combinations of heat and pressure can meld the materials of the assemblies together. Also, variation or addition of particular heat or compression can further meld materials together in certain selected areas, such as intersections of panels. Again using inner compartment 110 as an example, this results in the seamless appearance of the bottom 115 and ends 116 of sides 118 and 119 and the inner shape of inner pocket 134 as shown in FIGS. 1 to 4 and 8 to 11.

In a similar aspect, 3 layers of material are placed in a mold to make an inner or outer compartment 110 or 120. Using inner compartment 110 by example, the layers comprise a layer of fabric (exterior wall, skin material 410), then foam (core material 420) and then fabric (interior wall, skin material 410). The mold is sized for example at 8.5 width×11 length in inches. The mold is not flat. It is concaved to ultimately form a pouch shape. The 3 layers are placed in the mold in the fabric, foam, fabric sequence described above. Once the molding of the layers is complete, the molded layers are folded in half lengthwise whereby one end is folded to meet the other end. The sides 118, 119 are molded (i.e., including welded) together at ends 116, and the handbag 100 is formed in the shape of a pouch. In this case, the handbag 100 is approximately 8.5 width×5.5 length in inches.

In another aspect, the method of making a handbag inner compartment may also comprise creating a mold in a shape of a handbag 100 (e.g., a pouch shape) and filling the mold first with core material 420, aligning the magnets 111, 112, compressing the core material around the magnets, filling the mold with skin material 410 and molding the materials together. By molding the intersections of the core materials and skin materials, the handbag inner compartment can be devoid of visible seams on its exterior surface. E.g., see FIGS. 1 to 4 and 8 to 11 and bottom 115 and ends 116 of inner compartment 110.

In another aspect, the invention may be characterized as a method of making a handbag 100 comprising: creating a mold for an inner compartment 110 in a pouch shape of a handbag 100, the handbag 100 including a proximal opening 117, a distal edge 115, and first and second lateral sides 118 and 119, the proximal opening 117 further including a rim 114 around a circumference thereof; filling the mold with polyurethane or similar plastic foam material as the core material 420; filling the mold with synthetic fiber material as the skin material 410; and aligning a ferromagnetic material 111, 112 about the rim 114 and embedded within the core material 420, thereby creating a handbag inner compartment 110 with a seamless appearance.

In another aspect, the method is additionally characterized by sewing an outer compartment 120 configured to cover the inner compartment 110; and sewing metal material 121, 122 about a rim 124 of the outer compartment 120, the metal material 121, 122 configured to be juxtaposed with respect the ferromagnetic material 111, 112 and configured to be attracted to the ferromagnetic material.

Further, the method of making a handbag 100 can be characterized as comprising: stamping a grommet arrangement 129 into the rim 124 of the outer compartment 120; and looping a shoulder strap 128 through the grommet 129. This method further comprises choosing a distinctive design for the skin material 430 of the outer compartment 120. This method is further characterized wherein the aligning ferromagnetic material 111, 112, 121, 122 about and within the core materials 420 and 440 of the rims 114 and 125 comprises providing an elongated rectangular magnet.

While the Handbag System and Method as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. A handbag comprising:
An outer compartment and an inner compartment;
the outer compartment comprising a first proximal opening, a first distal edge, and first and second lateral sides, the distal edge and first and second lateral sides defining a first inner pocket, the first proximal opening further including a first rim around a circumference thereof, the first rim including a first exterior portion and a first interior portion, a first magnetized material embedded within the first interior portion of the first rim;
the inner compartment comprising a second proximal opening, the second proximal opening further including a second rim around a circumference thereof, the second rim including a second exterior portion and a second interior portion, a second magnetized material embedded within the second interior portion of the rim where the second proximal opening may be fixed in a closed position by the second magnetized material; and
where the inner compartment is capable of being placed within the first inner pocket of the outer compartment so that the first and second magnetized materials engage each other to secure the inner compartment within the outer compartment.

2. The handbag of claim 1 wherein the outer compartment further comprises a first core material and first skin material, where the first core material comprises the first interior portion, the first magnetized material is embedded in the first core material, and wherein the first core material is selected from the group consisting of polyurethane and other plastic foam material.

3. The handbag of claim 2 wherein the first skin material is selected from a group consisting of cloth, leather, plastic and synthetic fiber, and where the inner compartment includes a seam on the first and second lateral sides.

4. The handbag of claim 3 wherein the first magnetized material comprises elongated bendable rectangular metal material and has a longitudinal axis aligned substantially along the first rim.

5. The handbag of claim 2 wherein the inner compartment further comprises a second distal edge and third and fourth lateral sides, the second distal edge and third and fourth lateral sides define a second inner pocket, a second core material and second skin material, where the first core material comprises the second interior portion, the second magnetized material is embedded in the second core material, and wherein the second core material is selected from the group consisting of polyurethane or other plastic foam material.

6. The handbag of claim 5 wherein the second skin material is comprised of synthetic fiber and the inner compartment does not include visible seams.

7. The handbag of claim 6 wherein the second magnetized material comprises elongated magnets aligned along a longitudinal axis of the second rim.

8. The handbag of claim 7 further comprising first and second grommets located in the first rim adjacent to the first lateral side of the outer compartment and third and fourth grommets located in the first rim adjacent to the second lateral side of the outer compartment.

9. The handbag of claim 8 further comprising a strap connected to the first, second, third and fourth grommets.

10. The versatile handbag of claim 9 further comprising multiple inner compartments each with a distinct pattern incorporated into the second skin material of each inner compartment.

11. A versatile handbag comprising an inner compartment, the inner compartment comprising:
a first proximal opening, a first distal edge, and first and second lateral sides, the distal edge and first and second lateral sides defining a first inner pocket;
a core material selected from the group consisting of polyurethane and other plastic foam material;
an elongated rectangular magnet embedded within the core material having a longitudinal axis substantially about a rim of the inner compartment proximate to the first proximal opening; and
a material covering the core material selected from the group consisting of cloth, leather, plastic and synthetic fiber, wherein an exterior shape of the inner compartment is seamless.

12. The versatile handbag of claim 11 further comprising an outer compartment, the outer compartment including:
a second proximal opening, a second distal edge, and third and fourth lateral sides, the second distal edge and third and fourth lateral sides defining a second inner pocket defining a space within which the inner compartment fits;
an inner lining made of material selected from the group consisting of polyurethane foam, plastic form, cloth, leather, plastic and synthetic fiber;
a cover material selected from the group consisting of cloth, leather, plastic and synthetic fiber formed substantially to cover the inner lining, the cover material forming a seam on lateral sides of the outer compartment;
an elongated bendable rectangular metal material having a longitudinal axis substantially about a rim of the outer compartment proximate to the second proximal opening; and
wherein the metal material is configured to be juxtaposed to the rectangular magnet when the inner compartment is located in the second inner pocket of the outer compartment.

13. The versatile handbag of claim 12 further comprising first and second grommet arrangements adjacent to a first and second end of the elongated metal material and substantially aligned with the longitudinal axis of the metal material.

14. The versatile handbag of claim 13 wherein the first and second grommet arrangements each further comprise pairs of grommets located on opposing laterals sides of the outer compartment.

15. The versatile handbag of claim 14 further comprising a strap connected to the first and second grommet arrangements.

16. A method of making a handbag inner compartment comprising:
creating a mold providing a pouch shape for a handbag, the pouch shape for the handbag including a proximal opening, a distal edge, and first and second lateral sides, the proximal opening further including a rim around a circumference thereof;
filling the mold with a first material selected from the group comprising polyurethane and other plastic foam material;
aligning a ferromagnetic material along the rim and within the first material;
filling the mold with a second material selected from the group comprising spandex, lycra, nylon and plastic;
molding the first and second materials together.

17. The method of making a handbag of claim 16 further comprising:
molding the first and second materials together so that the distal edge does not include a visible seam on the exterior of the handbag inner compartment.

18. The method of making a handbag of claim 17 further comprising:
molding the first and second materials together so that the intersections of the first and second lateral sides do not form visible seams on the exterior of the handbag inner compartment.

19. The method of making a handbag of claim 18 further comprising:
sewing an outer compartment configured to cover the inner compartment; and
sewing metal material about a rim of the inner compartment, the metal material configured to be juxtaposed with respect the ferromagnetic material and configured to be attracted to the ferromagnetic material.

20. The method of making a handbag of claim 19 further comprising:
forming a grommet in the rim of the outer compartment; and
looping a shoulder strap through the grommet
